(19) United States
(12) Patent Application Publication
(10) Pub. No.: US 2026/0019101 A1
(43) Pub. Date: Jan. 15, 2026

(54) WIRELESS PERSONAL AREA NETWORK PERFORMANCE IN DENSE WIRELESS ENVIRONMENTS

(71) Applicant: Cypress Semiconductor Corporation, San Jose, CA (US)

(72) Inventors: Sandeep Sarma MUNUKUTLA, Bangalore (IN); Raghavendra Kencharla, Bangalore (IN)

(73) Assignee: Cypress Semiconductor Corporation, San Jose, CA (US)

(21) Appl. No.: 18/770,549

(22) Filed: Jul. 11, 2024

(51) Int. Cl. H04B 1/715; H04W 28/02; H04W 88/06

(52) U.S. Cl. CPC H04B 1/715; H04W 28/0252; H04B 2001/7154; H04B 2201/71323; H04W 88/06

(57) ABSTRACT

Methods and systems for improving wireless personal area network performance in dense wireless environments. The disclosed method includes, among other things, receiving, from a wireless personal area network (WPAN) sub-system of a wireless device, a frequency band congestion alert indicating congestion on a frequency band shared by the WPAN sub-system and a wireless local area network (WLAN) sub-system of the wireless device and causing the WPAN sub-system to update, in an adaptive frequency hopping (AFH) channel map of the WPAN sub-system, a classification of a first subset of a plurality of WPAN channels within the frequency band associated with a first WLAN channel of a plurality of WLAN channels within the frequency band utilized by the WLAN sub-system.

### TECHNICAL FIELD

This disclosure relates to wireless devices and, more specifically, to improving wireless personal area network performance in dense wireless environments.

### BACKGROUND

Multiple wireless devices using different communication protocols may share a common wireless medium. For example, Wireless Personal Area Network (WPAN) technologies, including Bluetooth® (BT), Bluetooth® Low Energy (BLE), Zigbee®, infrared, and Wireless Local Area Network (WLAN), including Wi-Fi® share a common wireless medium in a specific gigahertz (GHz) frequency band.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram of an exemplary wireless system, in accordance with implementations of the present disclosure.

FIG. 2 is an exemplary diagram of a set of channels for different communication protocols for a shared medium, in accordance with implementations of the present disclosure.

FIG. 3 depicts a dense wireless environment, in accordance with implementations of the present disclosure.

FIG. 4 depicts a dense wireless environment, in accordance with implementations of the present disclosure.

FIG. 5 depicts a flow diagram of an example method for improving wireless personal area network performance in dense wireless environments, in accordance with implementations of the present disclosure.

### DETAILED DESCRIPTION

Aspects of the present disclosure relate to improving wireless personal area network performance in dense wireless environments. Co-existence refers to when a WLAN sub-system coexist with another wireless technology (e.g., WPAN sub-system), in a shared environment, possibly on a single piece of hardware or within close proximity. Due to the co-existence of the WLAN sub-system and WPAN sub-system, their corresponding radios may interfere with one another when transmitting data on the same channel of a frequency band (e.g., an Industrial, Scientific, and Medical (ISM) frequency band) herein referred to as a shared medium.

Typically, time division multiplexing (TDM) is implemented on WLAN and WPAN sub-systems having controllers with low passive isolation to manage co-existence. More specifically, TDM refers to a method of dividing the channel utilized by both the WLAN sub-system and WPAN sub-system into time slots and assigning each sub-system (e.g., WLAN and WPAN sub-system) a specific time slot to transmit. This prevents WLAN and WPAN sub-systems from interfering with each other, even if they are operating on the same radio channel. Low passive isolation refers to the amount of isolation between the WLAN and WPAN radios which allows for more efficient use of the channel.

In some instances, to further mitigate against potential interference, a clear to send to self (CTS-2-Self) frame may be transmitted by the WLAN sub-system to itself. The CTS-to-Self frame includes an expiration time of the co-existing radio's activity (e.g., imminent WPAN sub-system) and indicates to other sub-systems (e.g., peer sub-systems) that the channel is being occupied for the duration of the expiration time. This helps notify the peer sub-systems that they should not transmit during this time, thereby avoiding collisions.

WPAN sub-system employs Frequency Hopping Spread Spectrum (FHSS) to manage potential interference between various devices operating in the frequency band. FHSS is a method of rapidly switching WPAN channels in the frequency band according to a hopping sequence to ensure harmonious coexistence by spreading transmissions across WPAN channels in the frequency band. This minimizes disruptions, allowing both subsystems to maintain reliable communication without interference. Typically, the hopping sequence is predetermined or pseudo-random. However, hopping sequences that are predetermined or pseudo-random is unable to adapt to changing environmental conditions, such as varying interference levels or channel conditions.

Typically, WPAN sub-systems employ Adaptive Frequency Hopping (AFH) to dynamically adjust the hopping sequence based on real-time feedback. WPAN sub-system equipped with AFH continuously monitors the quality of communication on each WPAN channel in the frequency band. WPAN sub-system assesses each WPAN channel by measuring various parameters, such as signal strength, noise level, error rates, and interference from other devices operating in the vicinity. Based on the assessment, WPAN sub-system classifies each WPAN channel as “good” in an AFH channel map indicating low levels of interference (e.g., lower than a specific threshold of interference), or “bad” in the AFH channel map indicating high levels of interference (e.g., higher than a specific threshold of interference). The AFH channel map is used to dynamically adjust the hopping sequence. In particular, the WPAN sub-system is directed to utilize WPAN channels that are classified as “good” in the AFH channel map, thereby avoiding WPAN channels classified as “bad.”

Typically, the WPAN sub-system preemptively classifies any WPAN channel with known interference as “bad” in the AFH channel map. For example, a WLAN channel utilized by the coexisting WLAN sub-system, known as the current operating WLAN channel, overlaps with one or more WPAN channels in the frequency band. The current operating WLAN channel operates at a center frequency within the frequency band having a predetermined bandwidth (e.g., 20 MHz bandwidth). The one or more WPAN channels that are within (or overlaps) a frequency range of the frequency band occupied by the current operating WLAN channel is classified as “bad” in the AFH channel map.

When the WPAN sub-system utilizes Bluetooth Low Energy (BLE), which typically operates using a total of 40 WPAN channels within the frequency band, roughly 10 WPAN channels are classified as “bad” in the AFH channel map due to overlapping with the current operating WLAN channel. In other words, 30 WPAN channels out of the 40 WPAN channels in the AFH channel map remains classified as “good.” When the WPAN sub-system utilizes Classic Bluetooth (often referred to as Bluetooth Basic Rate/Enhanced Data Rate or BR/EDR), which typically operates using a total of 79 WPAN channels within the frequency band, roughly 20 WPAN channels are classified as “bad” in the AFH channel map due to overlapping with the current operating WLAN channel. In other words, 59 WPAN channels out of 79 WPAN channels in the AFH channel map remains classified as “good.” This is done to prevent interference from the Basic Service Set (BSS) of the coexisting WLAN sub-system, which may include access points and associated client devices transmitting on the current operating WLAN channel.

In some instances, other WLAN devices in the vicinity may operate on various WLAN channels in the frequency band causing a dense environment. Dense environments refer to an area where there is a high concentration of wireless devices operating in close proximity to each other. This can lead to increased interference, congestion, and competition for available communication channels, which may degrade the performance and reliability of wireless networks. WPAN sub-system classifies, based on an assessment of the remaining WPAN channels, the WPAN channels overlapping the various WLAN channels occupied by the other WLAN devices as “bad” in the AFH channel map, thereby significantly reducing the number of WPAN channels classified as “good” in the AFH channel map. As a result, the WPAN sub-system is limited to a minimal number of WPAN channels for channel selection. Thus, the WPAN sub-system suffers from interference, increased re-transmissions, performance degradation, and higher power consumption.

Aspects and embodiments of the present disclosure address these and other limitations of the existing technology by causing the WPAN sub-system to update its AFH channel map based on an operating WLAN channel of the WLAN sub-system. For example, the WPAN sub-system may indicate to the WLAN sub-system that the WPAN sub-system is experiencing congestion on frequency band. In response, the WLAN sub-system provides an indication to the WPAN sub-system identifying a frequency range corresponding to a WLAN channel in which the WLAN sub-system is operating on. Based on the frequency range, the WPAN sub-system determines WPAN channels within the frequency range provide by the WLAN sub-system. The WPAN sub-system determines whether the WPAN channels are classified as “good” in the AFH channel map. If not, the WPAN sub-system classifies the WPAN channels as “good” in the AFH channel map. Thus, the AFH channel map may be updated to include WPAN channels associated with the operating WLAN channel so that the WPAN sub-system can operate on WPAN channels associated with the operating WLAN channel and benefit from TDM in dense environments.

Aspects of the present disclosure overcome these deficiencies and others by reducing the impact of interference from other wireless devices in a dense environment, thereby reducing re-transmission and improving WPAN performance.

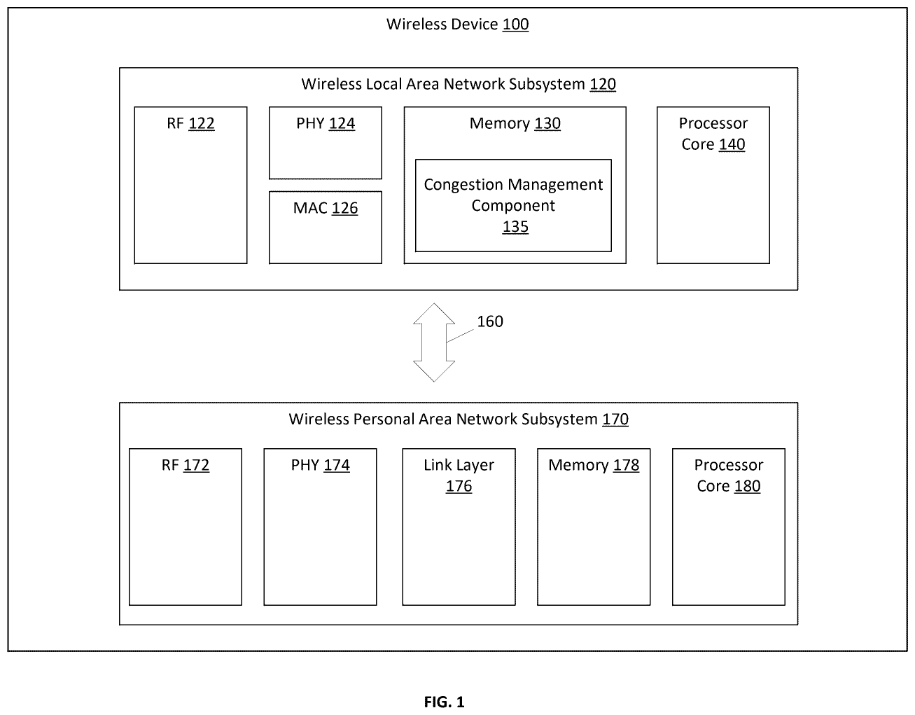

FIG. 1 is a block diagram of an exemplary wireless device 100, in accordance with implementations of the present disclosure. Wireless device 100 may include a WLAN sub-system 120 and a WPAN sub-system 170.

WLAN sub-system 120 includes, but is not limited to, a radio frequency front-end circuitry (RF) 122, a physical layer (PHY) 124, a media access control layer (MAC) 126, a memory 130, and a processor 140.

RF 122 is responsible for handling the radio signals involved in WLAN communication. RF 122 is coupled to one or more antennas of the wireless device 100 which receives and transmits radio signals. RF 122 may further include, but is not limited to, a low-noise amplifier (LNA), a power amplifier, one or more filters, and one or more switches. LNA is used to amplify the weak signals received by the antenna without significantly adding to the noise. Power amplifier increases the power of the signal to be sent out through the antenna, ensuring it is strong enough to reach the intended receiver. The one or more filters selects the appropriate frequency bands, such as 2.4 GHz or 5 GHz. The one or more switches alternate between transmission and reception modes in instances where a single antenna is used for both transmitting and receiving. In some embodiments, RF 122 may be a single component for multiple frequency bands or multiple components for each of the frequency bands.

PHY 124 is configured to transmit and receive radio signals over a frequency band (e.g., 2.4 GHz and/or 5 GHz bands). Additionally, PHY 124 is responsible for modulating data bits into a radio signal that can be transmitted, coordinating channel access with other wireless device (e.g., WLAN sub-systems or WLAN devices), and detecting/correcting errors that may occur during transmission. MAC 126 is responsible for managing and maintaining wireless communications, such as, Wi-Fi®. In particular, MAC 126 encapsulates data into frames with specific MAC addresses for transmission and decapsulation, employs protocol to manage medium access and minimize data transmission collisions, implements power-saving protocols to manage the energy use of the network interface, and, among other responsibilities, manages fair bandwidth allocation among all connected devices. Processor 140 is responsible for executing instructions stored in memory 130. The instructions, among other things, manages communication protocols, processing signals, coexistence strategies, etc. Memory 130 includes, but is not limited to, one or more volatile memory and/or non-volatile memory used for store instructions, firmware, operational data, etc.

WPAN sub-system 170 includes, but is not limited to, a RF 172, a PHY 174, a link controller 176, a memory 178, and a processor 180. Processor 180 is responsible for executing instructions stored in memory 178. Memory 178 includes, but is not limited to, one or more volatile memory and/or non-volatile memory.

RF 172, similar to RF 122 of WLAN sub-system 120, is responsible for handling the radio signals involved in WPAN communication (e.g., Bluetooth® (BT), BLE, Zigbee®, Z-Wave™, and the like). In some embodiments, RF 172 is coupled to an antenna of the one or more antennas of the wireless device 100 which receives and transmits radio signals. In some embodiments, RF 172 is coupled to an antenna separate and apart from the one or more antennas of the wireless device 100 coupled to RF 122 of WLAN sub-system. RF 122 may further include, but is not limited to, a low-noise amplifier (LNA), a power amplifier, one or more filters, and one or more switches. LNA is used to amplify the weak signals received by the antenna without significantly adding to the noise. Power amplifier increases the power of the signal to be sent out through the antenna, ensuring it is strong enough to reach the intended receiver. The one or more filters ensures that the WPAN sub-system 170 operates within its designated frequency band (e.g., 2.4 GHz band) and minimizes interference from other RF sources. The one or more switches alternate between transmission and reception modes in instances where a single antenna is used for both transmitting and receiving.

PHY 174 is configured to transmit and receive radio signals over a frequency band (e.g., 2.4 GHz) to enable wireless communication between other WPAN sub-systems and/or WLAN sub-systems. PHY 174 uses a variety of modulation schemes to achieve specific data rates and employs various techniques to improve the reliability of the communication, such as error detection and correction, frequency hopping, and time-division duplexing. Link controller 176 implements a link layer of a WPAN protocol stack and is responsible for transmitting and receiving data packets, managing the physical link, and handling errors. Link controller 176 interacts with a link manager, stored in memory 178, used to implement power saving and security aspects of the link layer protocol. Thus, the link manager provides information about the link status and to receive instructions.

WPAN protocol stack includes lower layers implemented by various components of the WPAN sub-system and/or device and higher layers implemented by a host. The lower layers include, for example, the physical layer implemented by PHY 174, and link layer implemented by link controller 176. The higher layers include, for example, a logical link control and adaptation (L2CAP) layer, an attribute protocol (ATT) layer, a generic attribute profile (GATT) layer, a security manager protocol (SMP) layer, and a generic access profile (GAP) layer. L2CAP layer provides crucial services for communication between WPAN sub-systems and/or devices. ATT layer provides a standardized approach to accessing and manipulating data on WPAN sub-systems and/or devices. GATT layer defines a hierarchical structure of attributes, organized into services and characteristics, providing a consistent and organized way to access and manipulate data related to specific WPAN applications. SMP layer safeguards communication between WPAN sub-systems and/or devices by establishing secure connections and protecting data from unauthorized access. GAP layer facilitates basic communication and discovery for sub-systems and/or devices by providing essential services, common features, and advertising and scanning capabilities.

Interface 160 refers to a communication protocol used to facilitate coexistence of the WLAN sub-system 120 and the WPAN sub-system 170, especially in situations where the WLAN sub-system 120 and the WPAN sub-system 170 operate in overlapping frequency band (e.g., 2.4 GHz band), herein referred to as “a shared medium.” Interface 160, for example, may be a 2-wire serial enhanced coexistence interface (SECI) or 3-wire generic coexistence interface (GCI). Interface 160 serves as communication channels between the WLAN sub-system 120 and the WPAN sub-system 170, allowing them to coordinate their operation. In particular, managing timing of transmissions, power levels, and channel selection.

Existing coexistence strategies stored on memory 130 of WLAN sub-system 120, when executed by the processor 140, manages the shared medium by using TDM to allocate specific time slots for transmission by the WLAN sub-system 120 and WPAN sub-system 170, ensuring coexistence without interfering with each other. The existing coexistence strategies, when executed by processor 140, causes the WLAN sub-system 120 to send CTS-2-Self frames with an expiration time associated with transmission of a WPAN packet of the WPAN sub-system 170 to itself, allowing the WLAN sub-system 120 to avoid transmitting during that time.

Memory 130 may include a congestion management component 135. In some embodiments, congestion management component 135 may be stored on memory 178 and executed by processor 180. In some embodiments, congestion management component 135 may be stored in other components of wireless device 100 and executed by processor 140 and/or 180. In some embodiments, congestion management component 135 may be stored externally (i.e., outside the wireless device) and executed by processor 140, 180, and/or an external processor.

In some embodiments, during initialization of the WPAN sub-system 170 generates an AFH channel map which may be stored on memory 178. During operation, the WPAN sub-system 170 utilizes the AFH channel map to determine which WPAN channels to include in its hopping sequence. For example, WPAN channels classified as “good” in the AFH channel map are included in the hopping sequence, while WPAN channels classified as “bad” are avoided or excluded from the hopping sequence. The WPAN sub-system 170 hops from WPAN channel to WPAN channel according to the hopping sequence defined by the AFH channel map by periodically switching WPAN channels to transmit and receive data, following the predetermined hopping pattern while avoiding WPAN channels with significant interference. As previously described, the AFH channel map stored in memory 178 is periodically updated based on changes in the shared medium.

In some embodiments, the WPAN sub-system 170 may determine whether the shared medium is congested. In some embodiments, the WPAN sub-system 170 determines that the shared medium is congested by satisfying a re-transmission threshold criterion and/or a channel classification threshold criterion.

The WPAN sub-system 170 determines that the re-transmission threshold criterion is satisfied indicating that the shared medium is congested by maintaining a number of re-transmission encountered on the shared medium. In particular, each time the WPAN sub-system 170 is forced to re-transmit a WPAN packet in response to an interruption in the transmission of the WPAN packet, the number of re-transmission is increased. Once the number of re-transmission encountered on the shared medium exceeds a re-transmission threshold value (i.e., a predetermined number of allowed re-transmissions), the WPAN sub-system 170 transmits, via interface 160, a frequency band congestion alert. The frequency band congestion alert indicates that the shared medium is being utilized by other devices, such as WLAN sub-systems other than WPAN sub-system 170 (e.g., one or more additional WLAN sub-systems).

The WPAN sub-system 170 determines that the channel classification threshold criterion is satisfied indicating that the shared medium is congested by identifying a number of WPAN channels of a plurality of WPAN channels in the AFH channel map classified as “bad.” During operation, as previously described, the WPAN sub-system 170 continuously monitors and assesses the plurality of WPAN channels in the shared medium for high levels of interference (e.g., higher than a specific threshold of interference). Once a WPAN channel of the plurality of WPAN channels are experience high levels of interference, the WPAN channel is classified as “bad,” (e.g., a first classification), while the WPAN channel of the plurality of WPAN channels experiencing low levels of interference (e.g., lower than a specific threshold of interference) is classified as “good” (e.g., a second classification). Once the number of WPAN channels classified as “bad” exceeds a classification threshold value (i.e., a predetermined number of WPAN channels classified as “bad”), the WPAN sub-system 170 transmits, via interface 160, a frequency band congestion alert.

Congestion management component 135, when executed by a processor (e.g., processor 140), in response to receiving the frequency band congestion alert from the WPAN sub-system 170, determines whether a subset of the plurality of WPAN channels overlapping with a current operating WLAN channel of the WLAN sub-system 120 (e.g., WPAN channels associated with the current operating WLAN channel) are classified as “good.” More specifically, the WLAN sub-system 120 provides, to the WPAN sub-system 170, a frequency range associated with the current operating WLAN channel of the WLAN sub-system 120 (e.g., current operating WLAN channel frequency range). Accordingly, the WPAN sub-system 170 identifies, based on the current operating WLAN channel frequency range, the WPAN channels associated with the current operating WLAN channel. The WPAN sub-system 170 determines whether the WPAN channels associated with the current operating WLAN channel are classified as “good.”

If the WPAN channels associated with the current operating WLAN channel is not classified as “good” (i.e., the WPAN channels associated with the current operating WLAN channel are classified as “bad”), congestion management component 135, causes the WPAN sub-system 170 to update, in the AFH channel map, a classification of the WPAN channels associated with the current operating WLAN channel as “good.” Classifying the WPAN channels associated with the current operating WLAN channel as “good” in the AFH channel map generates an updated AFH channel map. Thus, the WPAN sub-system 170 can hops from WPAN channel to WPAN channel according to the hopping sequence defined by the updated AFH channel map.

Congestion management component 135, concurrently or sequentially, determines a protection mechanism of the WLAN sub-system 120. The protection mechanism can include, for example, clear to send (CTS), ready to send (RTS), clear to send to self (CTS-2-Self), notice of absences (NOA), power management protection (PMP), etc. If the congestion management component 135 determines that the protection mechanism is not CTS-2-Self or NOA, the congestion management component 135 changes the protection mechanism to CTS-2-Self or NOA.

Congestion management component 135, concurrently or sequentially, determines whether the WLAN sub-system 120 is a soft access point (soft AP) (or an access point (AP)). Congestion management component 135 determines whether the WLAN sub-system 120 is a soft AP by analyzing one or more indicators and/or configurations of the WLAN sub-system 120. For example, a software configuration of the WLAN sub-system 120 may indicate that a soft AP mode is enabled, an operating mode of the WLAN sub-system 120 may indicate that the WLAN sub-system 120 is operating in soft AP mode, a network interface of the WLAN sub-system 120 may indicate the presences of a soft AP, a service set identifier (SSID) of the WLAN sub-system 120, etc.

If congestion management component 135 determines that the WLAN sub-system 120 is a soft AP, congestion management component 135 causes the WLAN sub-system 120 to establish a new operating WLAN channel. In particular, the WLAN sub-system 120 transmits, on each of the plurality of WLAN channels, a broadcast probe request to discover all nearby WLAN sub-systems, devices, or APs or to request information from all WLAN sub-systems, devices, or APs within range. In some embodiments, the broadcast probe request is transmitted with a destination media access control (MAC) address set to FF:FF:FF:FF:FF:FF.

WLAN sub-systems, devices, or APs within range of the WLAN sub-system 120 will receive the broadcast probe request and may respond with probe responses containing information about their network, including the SSID, supported security modes, signal strength, and other parameters. This allows the WLAN sub-system 120 monitor the plurality of WLAN channels to identify all WLAN sub-systems, devices, or APs on each WLAN channel. WLAN sub-system 120 identifies, based on the probe response received on each of the plurality of WLAN channels, a WLAN channel of the plurality of WLAN channels having the lowest level of interference (or least amount of WLAN activity) as a new operating WLAN channel for the WLAN sub-system 120.

In some embodiments, identifying the new operating WLAN channel can be determined based on the WLAN channel with the lowest number of probe responses. In some embodiments, more than one WLAN channel has the least number of probe response (i.e., two or more receive the same number of probe response and they are the least number of probe response for a given WLAN channel). Accordingly, the WLAN channel with the weakest probe responses is identified as the new operating WLAN channel. More specifically, the signal strength of each probe response in each of the more than one WLAN channel having the least number of probe response are accumulated. The WLAN channel of the more than one WLAN channel having the least number of probe response with the lowest accumulated signal strength is identifies as the new operating WLAN channel.

Once the new operating WLAN channel is identified, the WLAN sub-system 120 may set up a BSS on the new operating WLAN channel or migrate the BSS from the current operating WLAN channel to the new operating WLAN channel. Additionally, congestion management component 135 may cause the WPAN sub-system 170 to update, in the AFH channel map, a classification of a subset of the plurality of WPAN channels overlapping with the new operating WLAN channel of the WLAN sub-system 120 as “good.” As previously described, the WLAN sub-system 120 provides, to the WPAN sub-system 170, a frequency range associated with the new operating WLAN channel (e.g., new operating WLAN channel frequency range). The WPAN sub-system 170 identifies, based on the new operating WLAN channel frequency range, the subset of the plurality of WPAN channels within the new operating WLAN channel frequency range (e.g., WPAN channels associated with the new operating WLAN channel). The WPAN sub-system 170 classifies, in the AFH channel map, the WPAN channels associated with the new operating WLAN channel as “good” to generate a newly updated AFH channel map. Thus, the WPAN sub-system 170 can hops from WPAN channel to WPAN channel according to the hopping sequence defined by the newly updated AFH channel map.

Accordingly, in the event that there is congestion in the frequency band, during a time slot assigned to the WPAN sub-system 170, the WLAN sub-system 120 transmit a CTS-2-Self frame to itself including an expiration time of the WPAN activity (e.g., a WPAN packet) of the WPAN sub-system 170 indicating to other sub-systems that the operating WLAN channel (e.g., current operating WLAN channel or new operating WLAN channel) is being occupied for the duration of the expiration time. Since, the WPAN sub-system 170 is hopping from WPAN channel to WPAN channel according to the hopping sequence defined by the updated AFH channel (or newly updated AFH channel), the WPAN sub-system 170 is likely to utilize a WPAN channel associated with the operating WLAN channel which has been blocked off by the WLAN sub-system 120 via the CTS-2-Self frame.

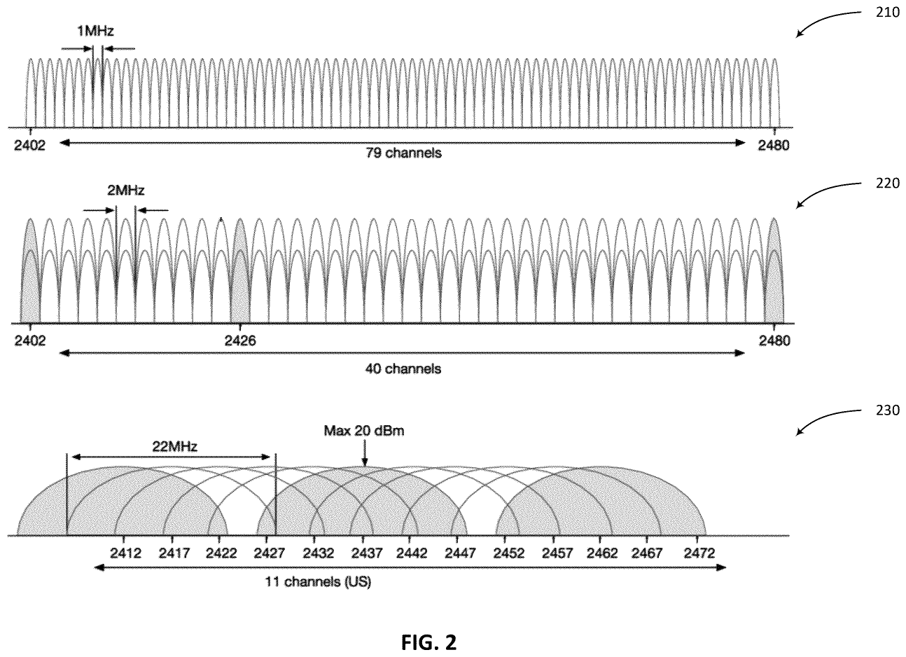

FIG. 2 illustrates frequency spectrum charts for the shared medium utilized by the WLAN sub-system 120 and the WPAN sub-system 170, in accordance with implementations of the present disclosure.

Frequency spectrum chart 210 provides a visual representation of the WPAN sub-system 170 utilizing BR/EDR protocol (or Bluetooth classic protocol) for communication on the shared medium (e.g., 2.4 GHZ). The shared medium is divided into a plurality of Bluetooth Classic channels (e.g., WPAN channels) (e.g., 79 Bluetooth Classic channels). Each Bluetooth Classic channel (e.g., 0-78) corresponds to a frequency centered around a specific frequency in the shared medium and has a bandwidth of 1 MHz. For example, Bluetooth Classic channel 0 has a center frequency of 2402 MHz in the shared medium and is 1 MHz wide, Bluetooth Classic channel 1 has a center frequency of 2403 MHz in the shared medium and is 1 MHz wide, and so on up to Bluetooth Classic channel 78.

Frequency spectrum chart 220 provides a visual representation of the WPAN sub-system 170 utilizing BLE protocol for communication on the shared medium (e.g., 2.4 GHz). The shared medium is divided into a plurality of BLE channels (e.g., WPAN channels) (e.g., 40 BLE channels) spaced apart by 2 MHz Each BLE channel (e.g., 0-39) corresponds to a frequency centered around a specific frequency in the shared medium and has a bandwidth of 2 MHZ. For example, BLE channel 0 has a center frequency of 2402 MHz in the shared medium and is 2 MHz wide, BLE channel 1 has a center frequency of 2404 MHz in the shared medium and is 2 MHz wide, and so on up to BLE channel 39.

Frequency spectrum chart 230 provides a visual representation of the WLAN sub-system 120 operating on the shared medium using a protocol from the IEEE 802.11 standard family of protocols for communication. The shared medium (e.g., 2.4 GHz) is divided into multiple WLAN channels (e.g., 11 WPAN channels). Each WLAN channel (e.g., 1-11) corresponds to a frequency centered around a specific frequency in the shared medium and has a bandwidth of 20 MHz The WLAN channels of the shared medium are spaced 5 MHz apart from their center frequency resulting in overlapping WLAN channels. For example, WLAN channel 1 has a center frequency of 2412 MHz in the shared medium and is 20 MHz wide, WPAN channel 2 has a center frequency of 2417 MHz in the shared medium and is 20 MHz wide, and so on up to WPAN channel 11. Accordingly, each WLAN channel overlaps with various WPAN channels (e.g., Bluetooth Classic channels or BLE channels). For example, WLAN channel 1 overlaps with Bluetooth Classic channels 0 to 22 and BLE channels 0 to 10, WLAN channel 2 overlaps with Bluetooth Classic channels 4 to 26 and BLE channels 2 to 12, and so on.

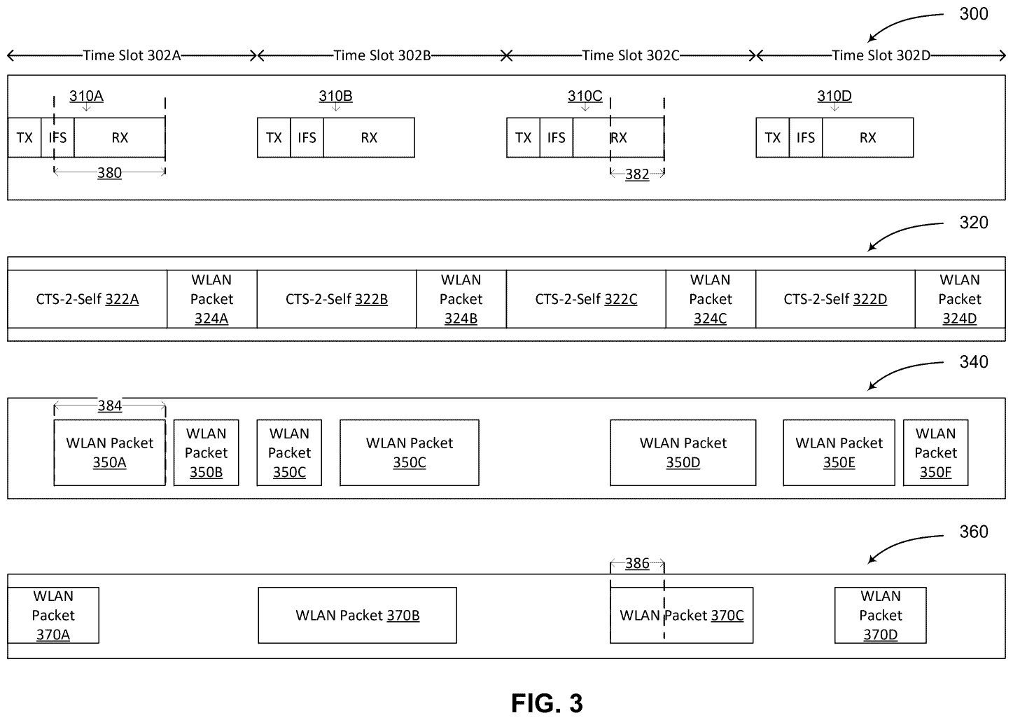

FIG. 3 depicts a dense wireless environment (e.g., congested shared medium) without the use of congestion management component 135 of FIG. 1, in accordance with implementations of the present disclosure. As noted above, shared medium may be divided into a plurality of time slots (e.g., time slot 302A-D).

WPAN activity 300 refers to one or more WPAN packets transmitted on various WPAN channels in the shared medium, based on an AFH channel map, by the WPAN sub-system 170. WLAN channel 320 refers to a WLAN channel of the shared medium (e.g., WLAN channel 6) in which the WLAN sub-system 120 operates (e.g., operating WLAN channel of the WLAN sub-system 120). WLAN packets 324A-D may be transmitted using WLAN channel 320. WLAN channel 340 refers to a WLAN channel of the shared medium (e.g., WLAN channel 1) in which WLAN sub-systems other than the WLAN sub-system 120 operates. WLAN packets 350A-F may be transmitted using WLAN channel 340. WLAN channel 360 refers to a WLAN channel of the shared medium (e.g., WLAN channel 11) in which WLAN sub-systems other than the WLAN sub-system 120 operates. WLAN packets 370A-D may be transmitted using WLAN channel 360.

WLAN sub-system 120 and WPAN sub-system 170 may implement TDM which divides and assigns time slots to each the WLAN sub-system 120 and WPAN sub-system 170 for use of the shared medium. As previously described, the WLAN sub-system 120 transmits CTS-2-Self frame to itself during time slots assigned to the WPAN sub-system 170.

During time slot 302A, WLAN sub-system 120 transmits CTS-2-Self frame 322A to itself for a duration of the WPAN packet 310A. Based on the AFH channel map, the WPAN sub-system 170 may transmit the WPAN packet 310A on a WPAN channel that overlaps with WLAN channel 340. Another WLAN sub-system may transmit WLAN packet 350A on WLAN channel 340 during a period of time in which WPAN packet 310A is being transmitted on the WPAN channel that overlaps with WLAN channel 340. Accordingly, portion 384 of WLAN packet 350A interrupts portion 380 of WPAN packet 310A causing a failed transmission of WPAN packet 310A.

During time slot 302B, WLAN sub-system 120 transmits CTS-2-Self frame 322B to itself for a duration of the WPAN packet 310B. Based on the AFH channel map, the WPAN sub-system 170 may transmit the WPAN packet 310B on a WPAN channel that overlaps with WLAN channel 320. WLAN sub-system 120, via the CTS-2-Self frame 322B, blocks the WPAN channels associated with the WLAN channel 320 for WPAN packet 310B.

During time slot 302C, WLAN sub-system 120 transmits CTS-2-Self frame 322C to itself for a duration of the WPAN packet 310C. Based on the AFH channel map, the WPAN sub-system 170 may transmit the WPAN packet 310C on a WPAN channel that overlaps with WLAN channel 360. Another WLAN sub-system may transmit WLAN packet 370C on WLAN channel 360 during a period of time in which WPAN packet 310C is being transmitted on the WPAN channel that overlaps with WLAN channel 360. Accordingly, portion 386 of WLAN packet 370C interferes with portion 382 of WPAN packet 310C causing a failed transmission of WPAN packet 310C.

During time slot 302D, WLAN sub-system 120 transmits CTS-2-Self frame 322D to itself for a duration of the WPAN packet 310D. Based on the AFH channel map, the WPAN sub-system 170 may transmit the WPAN packet 310D on a WPAN channel that overlaps with WLAN channel 320. WLAN sub-system 120, via the CTS-2-Self frame 322D, blocks the WPAN channels associated with the WLAN channel 320 for WPAN packet 310D.

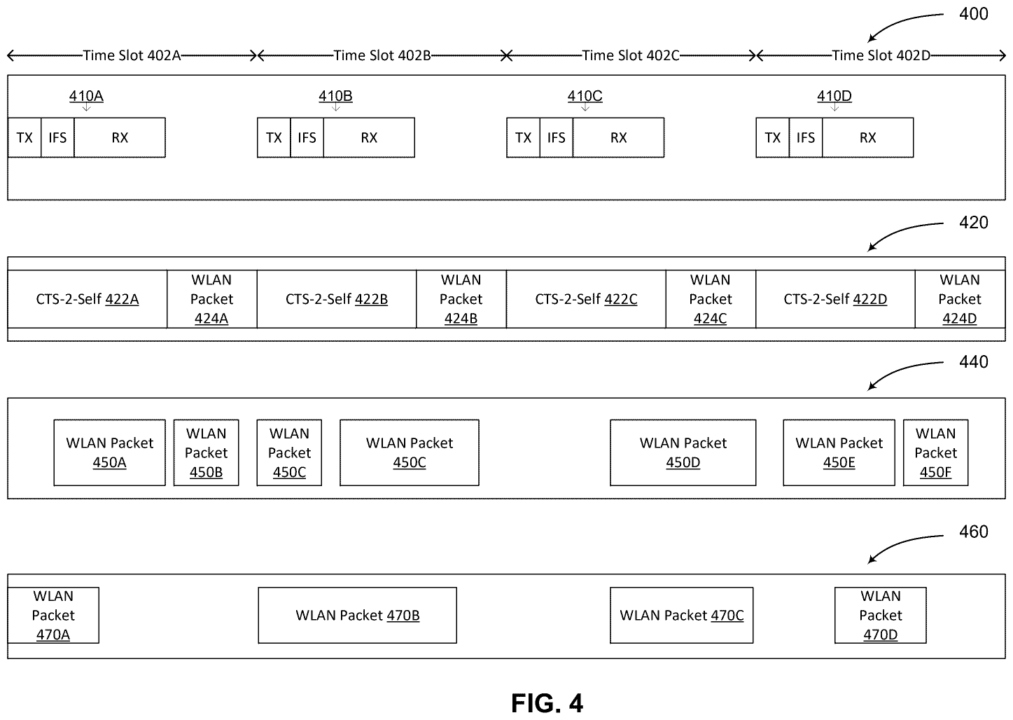

FIG. 4 depicts a dense wireless environment (e.g., congested shared medium) with the use of congestion management component 135 of FIG. 1, in accordance with implementations of the present disclosure. As noted above, shared medium may be divided into a plurality of time slots (e.g., time slot 402A-D).

WPAN activity 400, similar to WPAN activity 300 of FIG. 3, refers to one or more WPAN packets transmitted on various WPAN channels in the shared medium, based on an AFH channel map, by the WPAN sub-system 170. WLAN channel 420, similar to WLAN channel 320 of FIG. 3, refers to a WLAN channel of the shared medium (e.g., WLAN channel 6) in which the WLAN sub-system 120 operates (e.g., operating WLAN channel of the WLAN sub-system 120). WLAN packets 424A-D may be transmitted using WLAN channel 420. WLAN channel 440, similar to WLAN channel 340 of FIG. 3, refers to a WLAN channel of the shared medium (e.g., WLAN channel 1) in which WLAN sub-systems other than the WLAN sub-system 120 operates. WLAN packets 450A-F may be transmitted using WLAN channel 440. WLAN channel 460, similar to WLAN channel 360 of FIG. 3, refers to a WLAN channel of the shared medium (e.g., WLAN channel 11) in which WLAN sub-systems other than the WLAN sub-system 120 operates. WLAN packets 470A-D may be transmitted using WLAN channel 460.

WLAN sub-system 120 and WPAN sub-system 170 may implement TDM which divides and assigns time slots to each the WLAN sub-system 120 and WPAN sub-system 170 for use of the shared medium. As previously described, the WLAN sub-system 120 transmits CTS-2-Self frame to itself during time slots assigned to the WPAN sub-system 170.

During time slot 402A, WLAN sub-system 120 transmits CTS-2-Self frame 422A to itself for a duration of the WPAN packet 410A. Based on the AFH channel map, the WPAN sub-system 170 may transmit the WPAN packet 410A on a WPAN channel that overlaps with WLAN channel 440. Another WLAN sub-system may transmit WLAN packet 450A on WLAN channel 440 during a period of time in which WPAN packet 410A is being transmitted on the WPAN channel that overlaps with WLAN channel 440. Accordingly, portion 484 of WLAN packet 450A interrupts portion 480 of WPAN packet 410A causing a failed transmission of WPAN packet 410A.

Congestion management component (e.g., congestion management component 135 of FIG. 1) may receive, from WPAN sub-system 170, a frequency band congestion alert. The frequency band congestion alert may be as a result of the WPAN sub-system 170 needing to re-transmit WPAN packet 410A thereby increasing a number of re-transmission to exceed a re-transmission threshold value. The frequency band congestion alert may be as a result of the WPAN sub-system 170 marking additional WPAN channels as “bad” causing a number of WPAN channels classified as “bad” to exceed a classification threshold value. Congestion management component, in response to receiving the frequency band congestion alert, causes the WPAN sub-system 170 to update the AFH channel map, based on WLAN channel 420 (e.g., the operating WLAN channel of the WLAN sub-system 120), if the WPAN channels associated with WLAN channel 420 is not already classified as “good.” In some embodiments, congestion management component (e.g., congestion management component 135 of FIG. 1) may receive the frequency band congestion alert prior to time slot 402A or after time slot 402A. As previously described, the frequency band congestion alert is received in response to satisfying a re-transmission threshold criterion or a channel classification threshold criterion.

During time slot 402B, WLAN sub-system 120 transmits CTS-2-Self frame 422B to itself for a duration of the WPAN packet 410B. Based on the updated AFH channel map, the WPAN sub-system 170 may transmit the WPAN packet 410B on a WPAN channel that overlaps with WLAN channel 420. WLAN sub-system 120, via the CTS-2-Self frame 422B, blocks the WPAN channels associated with the WLAN channel 420 for WPAN packet 310B.

During time slot 402C, WLAN sub-system 120 transmits CTS-2-Self frame 422C to itself for a duration of the WPAN packet 410C. Based on the updated AFH channel map, the WPAN sub-system 170 may transmit the WPAN packet 410B on a WPAN channel that overlaps with WLAN channel 420, rather than WLAN channel 460 (as shown in WLAN channel 360 of FIG. 3). WLAN sub-system 120, via the CTS-2-Self frame 322D, blocks the WPAN channels associated with the WLAN channel 320 for WPAN packet 310D.

During time slot 402D, WLAN sub-system 120 transmits CTS-2-Self frame 422D to itself for a duration of the WPAN packet 410D. Based on the AFH channel map, the WPAN sub-system 170 may transmit the WPAN packet 410D on a WPAN channel that overlaps with WLAN channel 420. WLAN sub-system 120, via the CTS-2-Self frame 422D, blocks the WPAN channels associated with the WLAN channel 420 for WPAN packet 410D.

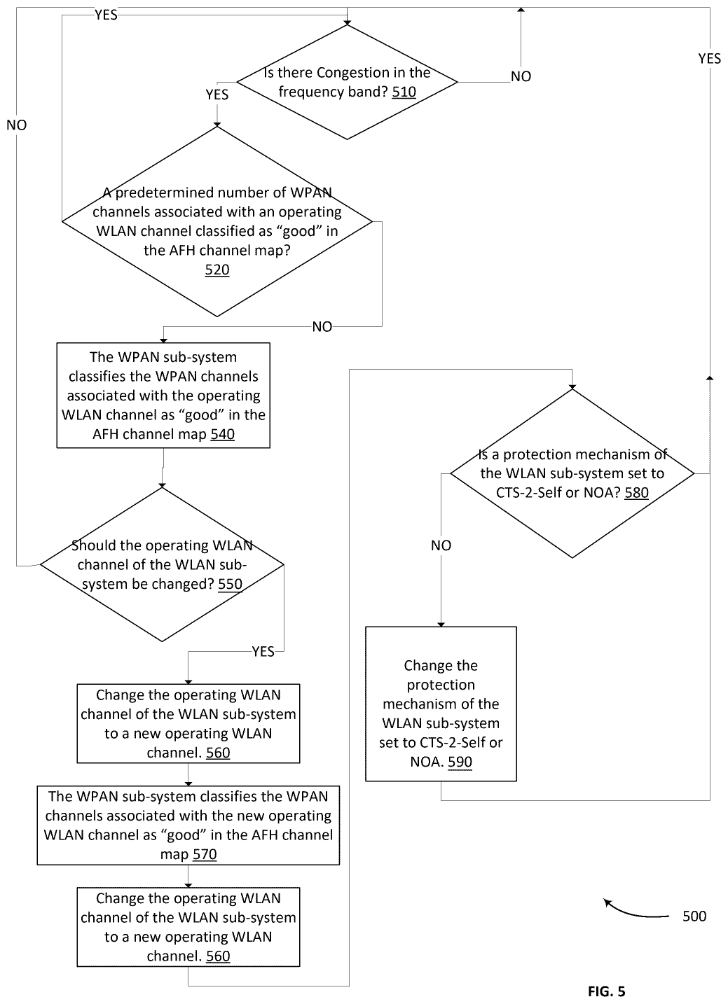

FIG. 5 depicts a flow diagram of an example method 500 for improving wireless personal area network performance in dense wireless environments, in accordance with implementations of the present disclosure. Method 500 can be performed by a processing logic that can include hardware (circuitry, dedicated logic, etc.), software (e.g., instructions run on a processing device), or a combination thereof. In one implementation, some, or all of the operations of method 500 can be performed by one or more components of WLAN sub-system 120 of FIG. 1. In some embodiments, some, or all of the operations of method 500 can be performed by congestion management component 135 of FIG. 1, as described above.

At block 510, the processing logic determines whether there is congestion in the frequency band. As previously described, congestion in the frequency band is determined by the WPAN sub-system by determining whether a re-transmission threshold criterion and/or a channel classification threshold criterion is satisfied. Re-transmission threshold criterion is satisfied in response a number of re-transmission encountered on the frequency band exceeds a re-transmission threshold value (i.e., a predetermined number of allowed re-transmissions). Channel classification threshold criterion is satisfied in response a number of WPAN channels classified as “bad” exceeds a classification threshold value (i.e., a predetermined number of WPAN channels classified as “bad”). If the re-transmission threshold criterion and/or the channel classification threshold criterion is satisfied, a frequency band congestion alert is transmitted to the WLAN sub-system indicating that the frequency band is being utilized by other devices, such as other WLAN sub-systems other than WPAN sub-system 170.

At block 520, responsive to determining that there is congestion in the frequency band, the processing logic determines whether a predetermined number of WPAN channels associated with an operating WLAN channel are classified as “good” in the AFH channel map. As previously described, the WLAN sub-system may provide the WPAN sub-system a frequency range associated with the operating WLAN channel of the WLAN sub-system which assist the WPAN sub-system in identifying the WPAN channels associated with the operating WLAN channel. The predetermined number of WPAN channels may be a percentage of the total number of WPAN channels (e.g., 90 percent).

Responsive to determining that the predetermined number of WPAN channels associated with an operating WLAN channel are classified as “good” in the AFH channel map, the processing logic proceeds to block 510. Otherwise, the processing logic proceed to block 540. At block 540, the processing logic causes the WPAN sub-system to classify the WPAN channels associated with the operating WLAN channel as “good” in the AFH channel map.

At block 550, the processing logic determines whether to change the operating WLAN channel of the WLAN sub-system to a new operating WLAN channel. As previously described, the processing logic determines whether the WLAN sub-system is a soft AP by analyzing one or more indicators and/or configurations of the WLAN sub-system. Responsive to determining that the WLAN sub-system is a soft AP, the WLAN sub-system transmits, on each of a plurality of WLAN channels in the frequency, a broadcast probe request. Based on the probe response received on each WLAN channel of the plurality of WLAN channels, the processing logic selects a WLAN channel with the lowest number of probe responses. If more than one WLAN channel has the lowest number of probe responses, the WLAN channel with the accumulative weakest signal strength is selected. If the selected identified as the new operating WLAN channel. If the selected WLAN channel is different from the operating WLAN channel, the operating WLAN channel should be changed to the selected WLAN channel (e.g., the new operating WLAN channel). Otherwise, the operating WLAN channel should remain unchanged.

At block 560, responsive determining that the operating WLAN channel of the WLAN sub-system should be changed to a new operating WLAN channel, the processing logic changes the operating WLAN channel of the WLAN sub-system to the new operating WLAN channel.

At block 570, responsive to changing the operating WLAN channel of the WLAN sub-system to the new operating WLAN channel, the processing logic causes the WPAN sub-system to classify the set of WPAN channels associated with the new operating WLAN channel as “good” in the AFH channel map.

At block 580, the processing logic determines whether a protection mechanism of the WLAN sub-system is set to CTS-2-Self or NOA. The protection mechanism may be CTS, RTS, CTS-2-Self, NOA, PMP, etc. At block 590, responsive to determining that the protection mechanism is not one CTS-2-Self or NOA, the processing logic changes the protection mechanism of the WLAN sub-system to CTS-2-Self or NOA.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, from a wireless personal area network (WPAN) sub-system of a wireless device, a frequency band congestion alert indicating congestion on a frequency band shared by the WPAN sub-system and a wireless local area network (WLAN) sub-system of the wireless device; and
causing the WPAN sub-system to update, in an adaptive frequency hopping (AFH) channel map of the WPAN sub-system, a classification of a first subset of a plurality of WPAN channels within the frequency band associated with a first WLAN channel of a plurality of WLAN channels within the frequency band utilized by the WLAN sub-system.

2. The method of claim 1, wherein the frequency band congestion alert is transmitted by the WPAN sub-system in response satisfying a re-transmission threshold criterion or a channel classification threshold criterion.

3. The method of claim 2, wherein the re-transmission threshold criterion is satisfied in response to a number of re-transmission of the WPAN sub-system exceeding a re-transmission threshold value.

4. The method of claim 2, wherein the channel classification threshold criterion is satisfied in response to a number of the plurality of WPAN channels classified with a first classification exceeds a classification threshold value, the first classification indicating that an interference level is higher than a specific threshold.

5. The method of claim 1, wherein causing the WPAN sub-system to update, in the AFH channel map of the WPAN sub-system, the classification of the first subset of the plurality of WPAN channels comprises:
for each WPAN channel of the first subset, classifying a respective WPAN channel with a second classification, the second classification indicating that an interference level is lower than a specific threshold.

6. The method of claim 1, further comprising:
transmitting, by the WLAN sub-system, a clear to send to self (CTS-2-Self) frame on the first WLAN channel during a time slot assigned the WPAN sub-system for WPAN activity; and
interrupting WLAN activity on the first WLAN channel for the WPAN activity.

7. The method of claim 1, further comprising:
responsive to receiving the frequency band congestion alert, identifying a second WLAN channel of the plurality of WLAN channels, wherein the second WLAN channel is a WPAN channel of the plurality of WLAN channels having the least amount of WLAN activity from one or more additional WLAN sub-systems utilizing the frequency band;
causing the WLAN sub-system to utilize the second WLAN channel for WLAN activity; and
causing the WPAN sub-system to update, in the AFH channel map of the WPAN sub-system, a classification of a second subset of the plurality of WPAN channels within the frequency band associated with the second WLAN channel.

8. The method of claim 7, wherein identifying the second WLAN channel comprises:
for each WLAN channel of the plurality of WLAN channels within the frequency band, transmitting a probe request;
for each WLAN channel of the plurality of WLAN channels, monitoring a respective WLAN channel for one or more probe responses, wherein each of the one or more probe responses corresponds to an additional WLAN sub-system of the one or more additional WLAN sub-systems utilizing the respective WLAN channel; and
identifying, among the plurality of WLAN channels, a WLAN channel having a lowest number of probe responses as the second WLAN channel.

9. The method of claim 1, wherein causing the WPAN sub-system to update the classification of the first subset responsive to determining that the first subset is classified in the AFH channel map with a first classification.

10. A wireless device comprising:
a wireless local area network (WLAN) sub-system comprising a processor, and
a wireless personal area network (WPAN) sub-system operating on a frequency band shared with the WLAN sub-system, wherein the processor of the WLAN sub-system is to perform operations comprising:
receiving, from the WPAN sub-system, a frequency band congestion alert indicating congestion on the frequency band; and
causing the WPAN sub-system to update, in an adaptive frequency hopping (AFH) channel map of the WPAN sub-system, a classification of a first subset of a plurality of WPAN channels within the frequency band associated with a first WLAN channel of a plurality of WLAN channels within the frequency band utilized by the WLAN sub-system.

11. The wireless device of claim 10, wherein the frequency band congestion alert is transmitted by the WPAN sub-system in response satisfying a re-transmission threshold criterion or a channel classification threshold criterion.

12. The wireless device of claim 11, wherein the re-transmission threshold criterion is satisfied in response to a number of re-transmission of the WPAN sub-system exceeding a re-transmission threshold value.

13. The wireless device of claim 11, wherein the channel classification threshold criterion is satisfied in response to a number of the plurality of WPAN channels classified with a first classification, the first classification indicating that an interference level is higher than a specific threshold.

14. The wireless device of claim 10, wherein causing the WPAN sub-system to update, in the AFH channel map of the WPAN sub-system, the classification of the first subset of the plurality of WPAN channels comprises:
for each WPAN channel of the first subset, classifying a respective WPAN channel with a second classification, the second classification indicating that an interference level is lower than a specific threshold.

15. The wireless device of claim 10, wherein the processor of the WLAN sub-system is to perform operations comprising:
transmitting, by the WLAN sub-system, a clear to send to self (CTS-2-Self) frame on the first WLAN channel during a time slot assigned the WPAN sub-system for WPAN activity; and
interrupting WLAN activity on the first WLAN channel for the WPAN activity.

16. The wireless device of claim 10, wherein the processor of the WLAN sub-system is to perform operations comprising:
responsive to receiving the frequency band congestion alert, identifying a second WLAN channel of the plurality of WLAN channels, wherein the second WLAN channel is a WPAN channel of the plurality of WLAN channels having the least amount of WLAN activity from one or more additional WLAN sub-systems utilizing the frequency band;
causing the WLAN sub-system to utilize the second WLAN channel for WLAN activity; and
causing the WPAN sub-system to update, in the AFH channel map of the WPAN sub-system, a classification of a second subset of the plurality of WPAN channels within the frequency band associated with the second WLAN channel.

17. The wireless device of claim 16, wherein identifying the second WLAN channel comprises:
for each WLAN channel of the plurality of WLAN channels within the frequency band, transmitting a probe request;
for each WLAN channel of the plurality of WLAN channels, monitoring a respective WLAN channel for one or more probe responses, wherein each of the one or more probe responses corresponds to an additional WLAN sub-system of the one or more additional WLAN sub-systems utilizing the respective WLAN channel; and
identifying, among the plurality of WLAN channels, a WLAN channel having a lowest number of probe responses as the second WLAN channel.

18. The wireless device of claim 10, wherein causing the WPAN sub-system to update the classification of the first subset responsive to determining that the first subset is classified in the AFH channel map with a first classification.

19. A wireless local area network (WLAN) sub-system of a wireless device, comprising:
a processor; and
a memory comprising a congestion management component, wherein the congestion management component when executed by the processor is to perform operations comprising:
receiving, from a wireless personal area network (WPAN) sub-system of the wireless device, a frequency band congestion alert indicating congestion on a frequency band shared by the WPAN sub-system and the WLAN sub-system of the wireless device; and
causing the WPAN sub-system to update, in an adaptive frequency hopping (AFH) channel map of the WPAN sub-system, a classification of a first subset of a plurality of WPAN channels within the frequency band associated with a first WLAN channel of a plurality of WLAN channels within the frequency band utilized by the WLAN sub-system.

20. The WLAN sub-system of claim 19, wherein the congestion management component when executed by the processor is to perform operations further comprising:
transmitting, by the WLAN sub-system, a clear to send to self (CTS-2-Self) frame on the first WLAN channel during a time slot assigned the WPAN sub-system for WPAN activity; and
interrupting WLAN activity on the first WLAN channel for the WPAN activity.
